(19) United States
(12) Patent Application Publication
(10) Pub. No.: US 2009/0252650 A1
(43) Pub. Date: Oct. 8, 2009

(54) PORTABLE MEMS-BASED SPECTRAL IDENTIFICATION SYSTEM

(76) Inventor: Sridhar Lakshmanan, Belleville, MI (US)

Correspondence Address: Benita J Rohm;Rohm & Monsanto, 12 Rathbone Place, Grosse Pointe, MI, 48230, US

(21) Appl. No.: 12/310,266

(22) PCT Filed: Aug. 16, 2007
(86) PCT No.: PCT/US2007/018347

§ 371 Date: Feb. 17, 2009

Related U.S. Application Data
(60) Provisional application No. 60/838,526, filed on Aug. 16, 2006.

(51) Int. Cl. G01N 21/00

(52) U.S. Cl. 422/91

(57) ABSTRACT

A sensing arrangement detects a compound of interest within a gas sample. An amplifying fluorescent polymer produces an output signal that varies in response to an interaction of the amplifying fluorescent polymer with the compound of interest. Additionally, an infrared illumination source produces infrared electromagnetic energy that causes the amplifying fluorescent polymer to generate the output signal. A MEMS detector is positioned to receive the output signal generated by the amplifying fluorescent polymer, and produces an output electrical signal that is responsive to an interaction between the compound of interest and the amplifying fluorescent polymer. The output electrical signal is responsive to a quenching of the output signal of the amplifying fluorescent polymer. A pattern database stoics pattern data corresponding to characteristics of compounds of interest.

### RELATIONSHIP TO OTHER APPLICATION

This application claims the benefit of the filing date of U.S. Provisional Patent Application Ser. No. 60/838,526, filed Aug. 16, 2006.

### BACKGROUND OF THE INVENTION

1. Field of the Invention

This invention relates generally to chemical sensing systems, and more particularly, to a portable chemical sensing arrangement that detects trace amounts of predetermined chemicals in a gas.

2. Description of the Related Art

The detection of certain compounds of interest is essentially a problem of identifying organic and inorganic chemical groups in samples. The dispersion of such compounds in the air can be divided into trace (small) and bulk (large) amounts, based on the size of the airborne particles. In security applications, there exists a need to detect trace amounts of airborne chemical particles using portable (handheld or mounted on a robot) devices. Commonly explored techniques for trace amount detection include ion mass spectroscopy, chemiluminescence, electrochemical, photoacoustics, thermo-optics, absorption spectroscopy, raman spectroscopy, and gas chromatography.

Absorption spectroscopy is a common laboratory technique that is used to identify groups of compounds of interest. The systems required for implementation of this technique, however, are not portable, require sample preparation, and analysis of the result. Thus, significant human intervention is required.

Chemical sensors are known to use secondary detections a result of which one can infer the presence of the compound(s) of interest. Typically, the compound of interest experiences a sequence of events that ultimately produce an electrical signal. By way of example, a compound of interest is decomposed into an oxide that is then applied to quench an emitting material. Such detection systems detect the compound of interest indirectly, and therefore operate at a reduced efficiency, whereby trace concentrations of the compound of interest are not easily detected.

The following table summarizes commercially available devices that are used to detect trace amounts of airborne chemical compounds:

| Company/Product | Detection Technique | Configuration |
|---|---|---|
| Scintrex Trace Corp./EVD 3500 | Chemiluminescence | Handheld |
| Scintrex Trace Corp./EVD 2500 | Electrochemical (Thermo-Redox) | Handheld |
| Implant Sciences/QS-H100 | Ion Mobility Spectrometry | Handheld |
| | Laser Ionization | |
| Nomadics/FIDO X_series | Amplifying Fluorescent Polymers | Handheld |
| Smiths Detection/GC-IONSCAN | Gas Chromatography | Desktop |
| Electronic SensorTechnology/GC-4100 | Gas Chromatography | Handheld |
| Thermo Electron | Gas Chromatography | Desktop |
| Corporation/EGIS_Defender | Differential Ion Mobility Spectrometry | |
| Smiths Detection/IONSCAN | Ion Mobility Spectrometry | Desktop |
| Electronic Sensor | Gas Chromatography | Desktop |
| Technology/EST_7100 | | |

Despite the commercial availability of these known devices and systems, their widespread use is restricted by several factors. A first factor is cost, as the least expensive of these systems costs US $30,000. In addition, the more widely used systems rely on old technology and do not take advantage of modern advances in micro-systems technology. The use of micro-systems would result in reduced power usage, as well as enhanced compactness, reliability, and affordability.

In a laboratory, the absorption spectrum is a commonly used signature that characterizes chemical groups. For a given sample, its absorption spectra can be obtained with a known spectrophotometer. Such systems, however, are not suitable for field operations because of their size, high power consumption, the need for human intervention, and the length of time needed to effect detection.

It is, therefore, an object of this invention to provide a field device that will not require any human intervention, sample preparation, or results analysis, etc.

It is another object of this invention to provide a field device that can be either handheld or integrated into a mobile robotic platform.

It is also an object of this invention to provide a chemical detector system that can directly sense the presence of a target compound, thereby improving the efficiency of die detection of the compound of interest and reducing the potential for loss and interference

### SUMMARY OF THE INVENTION

The foregoing and other objects are achieved by this invention which provides a detector arrangement for detecting a compound that is present in an air sample. A chamber for receiving the air sample and has an inlet and an outlet, each of which communicates with the enclosed sensing volume. The air sample is urged into the chamber by a pump arrangement. An illumination arrangement causes electromagnetic energy having a first spectral characteristic to be propagated through the air sample, and a sensor having an amplifying fluorescent polymer is disposed within the chamber. The sensor communicates with the air sample. A detector receives a portion of the electromagnetic energy, and has an output for issuing an output signal responsive to the spectral characteristic of the received portion of the electromagnetic energy. The received portion of the electromagnetic energy has a second spectral characteristic that differs from the first spectral characteristic in response to the compound.

In one embodiment, the illumination arrangement is a source of infrared energy. The detector is, in certain embodiments, a tunable infrared detector.

In a highly advantageous embodiment, a pattern database stores pattern data that corresponds to characteristics of compounds of interest. A processor compares data contained in the output signal of the detector to the pattern data stored in the pattern database. Preferably, die pattern data corresponds to a spectral absorption characteristic.

In a preferred embodiment the detector is a MEMS detector that is arranged to receive an illumination produced by the sensor.

In accordance with a further apparatus aspect of the invention, there is provided a sensing arrangement that detects a compound of interest within a gas sample. An amplifying fluorescent polymer produces an output signal that varies in response to an interaction of the amplifying fluorescent polymer with the compound of interest. Additionally, an infrared illumination source produces infrared electromagnetic energy that causes the amplifying fluorescent polymer to generate the output signal. A MEMS detector is positioned to receive the output signal generated by the amplifying fluorescent polymer, and produces an output electrical signal that is responsive to an interaction between the compound of interest and the amplifying fluorescent polymer.

In one embodiment of this further apparatus aspect of the invention, the output electrical signal is responsive to a quenching of the output signal of the amplifying fluorescent polymer. A pattern database stores pattern data corresponding to characteristics of compounds of interest.

In accordance with a further aspect of the invention, there is provided a system for detecting explosives of interest from a standoff distance in response to chemical vapors associated with the explosives of interest. The explosives of interest are of the type that absorb infrared energy at predetermined wavelength notches in the 2-20 micron band. In accordance with this aspect of the invention, there is provided a chamber for receiving the chemical vapors desired to be detected. A heat source emits infrared radiation into the chamber. The infrared radiation has and energy characteristic in the spectral region of the 2-20 micron band. In addition, a spectrally tuned infrared detector detects a change in the infrared energy in the predetermined wavelength notches in the 2-20 micron band.

In one embodiment of this further aspect of the invention, the chemical vapors associated with the explosives of interest are, without limitation, selected from the group consisting of TNT, RDX, HMX, PETN, Tetryl, NG, NC, Taggants (DMNB and EGDN), C-4, SEMTEX, ANFO. Plastic bonded explosives, such as PE and LTPA are explosives of interest in some embodiments. Also, non-nitro explosives, such as TATP and HMTD, are selectable for detection.

The spectrally tuned infrared detector includes an infrared camera having spectrally selective diffractive optics. The selection of the spectral sensitivity of the diffractive optics is determined in one embodiment by linear discriminant methods.

In a further embodiment, the spectral sensitivity of the diffractive optics is determined by mechanical articulation of the diffractive optics.

The spectrally tuned infrared detector in, in some embodiments, a thermally cooled infrared camera.

The use of MEMS reduces the power, size, and cost of the detection device, thereby facilitating portability. The time for detection is also reduced. The integration of MEMS detectors with absorption spectroscopy results in the ability to identify multiple chemical compounds simultaneously. By cross-referencing multiple spectral signatures of a single chemical compound, low numbers of false alarms and high probabilities of detection for bulk and trace concentrations of the compounds of interest are achieved.

In accordance with the invention, there is provided a field-operable MEMS device that in some respects operates in a manner that is similar to a desktop (laboratory) spectrophotometer. The device employs a vacuum chamber into which air is drawn. A known broadband light source causes infrared radiation to be propagated from one side of the air chamber to the other. Particles of the compound(s) in the air chamber absorb the incident infrared energy in determinable wave bands, depending on their chemical composition. A tunable infrared detector is used to determine the relative absorption of energies by the air chamber particles as a function of wavelength. This absorption spectrum is compared against a database of benchmark spectra for known chemicals or compounds of interest, using statistical pattern recognition techniques. This results in the detection and identification of trace amounts of compounds of interest in the sample of air that has been drawn into the vacuum chamber.

As described herein, the present invention is an explosive detection system that relies on the identification of specific organic and inorganic chemical groups that are used for making common explosives. This group includes aromatic ester, aromatic nitrate, and nitramine. To the extent that chemical and biological weapons are also assembled using similar chemical groups, the detection techniques described in this proposal also carry over to that domain.

In a laboratory, absorption spectrum is a commonly used signature for characterizing chemical groups. Given a sample, its absorption spectra can be obtained by using a Fourier transform infrared spectrophotometer (“FTIR”). Unfortunately, although FTIRs are useful in a laboratory setting, they suffer from a number of drawbacks when used in a field operation—size, power, need for human intervention, time for detection, etc. These systems also require sufficient concentrations of the chemicals in the samples being tested.

A field-operable device constructed in accordance with the principles of the present invention uses absorption spectroscopy. The system of the present invention can be used for both bulk and trace explosives screening applications. The field device does not require any human intervention, sample preparation, results analysis, etc. Moreover, the field-operable device can be configured to be either handheld or integrated into a mobile robotic platform.

This field-operable micro-electro-mechanical-system (MEMS) device mimics, in some respects, a desktop (laboratory) FTIR. A specific illustrative embodiment of the invention employs a vacuum chamber to draw in air. A broadband heat source propagates infrared radiation from one side of the air chamber to the other. Particles in the air chamber absorb the incident infrared energy in certain wavebands, depending on their chemical composition. A spectrally tuned infrared detector is used to analyze in real-time the relative absorption of energies at predetermined wavelengths by the air chamber particles. This absorption spectrum is compared against a database of benchmark spectra for known explosive chemicals, using statistical pattern recognition techniques. This results in the detection and identification of trace explosive elements in the samples.

It is to be noted that, unlike a conventional FTIR, the system of the present invention is not an interferometer-based arrangement and consequently there are no associated careful field-calibrations.

The present invention is quite different from known arrangements. A significant aspect of the present invention is the use of infrared micro-electromechanical systems (“MEMS”). The use of MEMS increases the sensitivity, and reduces the power, size, and cost of the detection device, by several orders. The time for detection is also reduced, thereby enabling detection and identification of trace amounts of explosives in the sample using a field-operable device. Integration of MEMS detectors with absorption spectroscopy results in the ability to identify multiple chemical compounds simultaneously. By cross-referencing multiple spectral signatures of a single chemical compound, the system of the present invention achieves low false alarm and high probability of detection rates for both bulk and trace concentrations.

It is possible to synthesize a polymer for achieving signal amplification. In this regard, it is envisioned that in the presence of heavy contamination the native spectral lines between signal (chemical groups pertaining to the explosives of interest) and noise (chemical groups pertaining to the contaminant chemical groups) will become blurred. Under these circumstances it would be beneficial for the signal to be amplified so that the chemical groups pertaining to the explosives of interest can be detected in the presence of heavy noise. Conjugated polymers that possess duality bind with the chemical groups of interest and have an absorption spectrum signature that is unambiguously identifiable upon binding occurrence. Such polymers are known, and include, for example, poly(p-phenyleneethynylene) (“PPE”) and poly(p-phenylenevinylene) (“PPV”).

### BRIEF DESCRIPTION OF THE DRAWING

Comprehension of the invention is facilitated by reading the following detailed description, in conjunction with the annexed drawing, in which:

FIG. 1 is a simplified schematic and function block representation of a specific illustrative embodiment of the invention;

FIG. 2 is a function block representation of a specific illustrative embodiment of the invention; and

FIG. 3 is a graphical representation of the sensitivity achieved by a specific illustrative embodiment of the present invention.

### DETAILED DESCRIPTION

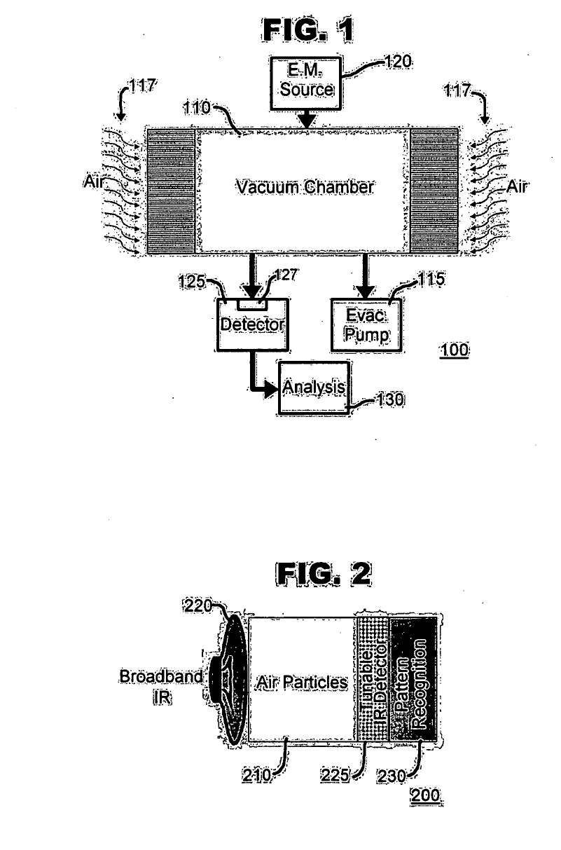

FIG. 1 is a simplified schematic and function block representation of a specific illustrative embodiment 100 of the invention. In this embodiment, the infrared spectrum is employed, and therefore is useful in the detection of compounds within chemical groups that have distinct absorption bands in the 2-15 μm wavelengths.

As shown in this figure, the specific illustrative embodiment of the invention is a detector arrangement 100 constructed in accordance with the principles of the invention. A vacuum chamber 110 is configured to receive ambient air at inlet ports 117. The ambient air is urged into the vacuum chamber by operation of an evacuation pump 115. As air is evacuated from vacuum chamber 110, the ambient air is drawn unto the vacuum chamber.

The ambient air is comprised of particles of interest, which may illustratively include molecules of ammonium nitrate, potassium nitrate, ammonium per chlorate, trinitrotoluene, cyclorimethylene trinitramine, pentaerythritol tetranitrate, nitroglycerine, etc. Chemical groups of interest illustratively include: C—NO₂; C—O—NO₃, and C—N—NO₂. The particles are subjected to electromagnetic illumination, illustratively in the infrared spectral region. The electromagnetic illumination is issued by an electromagnetic source 120.

In one specific illustrative embodiment of the invention, variations in the characteristics of the electromagnetic illumination are detected at a detector 125. The detector is, in some embodiments, an infrared camera having associated therewith a lens 127. In some embodiments, the lens constitutes spectrally selective diffractive optics, and the spectral sensitivity of the diffractive optics is determined by linear discriminant methods. In other embodiments, the spectral sensitivity of the diffractive optics is determined by mechanical articulation of the diffractive optics.

The variations in the characteristic of the electromagnetic illumination are responsive to the quantity and chemical characteristics of the particles of interest. the detected variations then are subjected to analysis at an analyzer 130. in a specific illustrative embodiment of the invention, analyzer 130 is configured to be responsive to patterns of in the variations in the characteristic of the electromagnetic illumination.

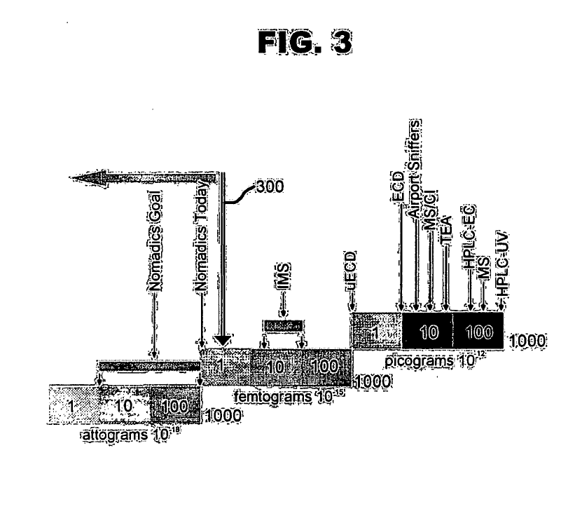

FIG. 2 is a function block representation of a specific illustrative embodiment 200 of the invention. As shown in this figure, broadband infrared electromagnetic illumination is provided by an infrared source 220. The electromagnetic illumination is directed to impinge upon particles that are contained within a chamber 210. The resulting variation in one or more characteristics of the electromagnetic illumination after passing through the particles is detected, in this specific illustrative embodiment of the invention, by a tunable infrared detector 225. The output signal (not specifically designated) of tunable infrared detector 225 is subjected to analysis in this embodiment by a pattern recognition system 230. The pattern recognition system will provide to the user (not shown) an indication of the identity of the particle(s) of interest contained in chamber 210.

It is to be noted that the arrangement of the present invention is not an interferometer-based device, and accordingly there is no requirement for field-problematic careful adjustments, leveling, etc. A spectrally tuned MEMS infrared detector can detect five different compounds simultaneously.

FIG. 3 is a graphical representation of the sensitivity achieved by a specific illustrative embodiment of the present invention, in the context of the sensitivity of other known arrangements. As indicated by arrow 300 in this figure, the present invention detects concentrations of certain compounds on the order of a few fentograms. Other known arrangements referenced in this figure, listed in the order of increasing sensitivity, include:
HPLC-UV—High-Pressure Liquid Chromatography with UV Detector
MS—Mass Spectrometry
HPLC-EC—High-Pressure Liquid Chromatography with Electrical Conductivity
TEA—Triethylamine Detection
MS/Cl—Mass Spectrometry/Chemical Ionization
Airport Sniffers—Airport Sniffer Dogs
ECD—Electron Capture Detector
μECD—Micro Electron Capture Detector
IMS—Ion Mass Spectrometer
Present Day Nomadics—Explosives Detectors by Nomadics, Inc.
Nomadics Goal—Future Explosives Detectors, by Nomadics, Inc.

Although the invention has been described in terms of specific embodiments and applications, persons skilled in the art may, in light of this teaching, generate additional embodiments without exceeding the scope or departing from the spirit of the invention described herein. Accordingly, it is to be understood that the drawing and description in this disclosure are proffered to facilitate comprehension of the invention, and should not be construed to limit the scope thereof.

What is claimed is:

1. A detector arrangement for detecting a compound that is present in an air sample, the arrangement comprising:
a chamber for receiving the air sample, said chamber having an inlet and an outlet communicating with the enclosed sensing volume;
a pump arrangement for urging the air sample into said chamber;
an illumination arrangement for causing electromagnetic energy having a first spectral characteristic to be propagated through the air sample;
a sensor having an amplifying fluorescent polymer disposed within said chamber, said sensor being disposed to communicate with the air sample; and
a detector for receiving a portion of the electromagnetic energy, said detector further having an output for issuing an output signal responsive to the spectral characteristic of the received portion of the electromagnetic energy, the received portion of the electromagnetic energy having a second spectral characteristic that differs from the first spectral characteristic in response to the compound.

2. The detector arrangement of claim 1, wherein said illumination arrangement is a source of infrared energy.

3. The detector arrangement of claim 2, wherein said detector is a tunable infrared detector.

4. The detector arrangement of claim 1, wherein there is further provided a pattern database for storing pattern data corresponding to characteristics of compounds of interest.

5. The detector arrangement of claim 4, wherein there is further provided a processor for comparing data contained in the output signal of said detector to the pattern data stored in said pattern database.

6. The detector arrangement of claim 4, wherein said pattern data corresponds to a spectral absorption characteristic.

7. The detector arrangement of claim 1, wherein said detector is a MEMS detector.

8. The detector arrangement of claim 1, wherein said detector receives an illumination produced by said sensor.

9. A sensing arrangement for detecting a compound of interest within a gas sample, the sensing arrangement comprising:
an amplifying fluorescent polymer for producing an output signal that varies in response to an interaction of the amplifying fluorescent polymer with the compound of interest;
an infrared illumination source for producing infrared electromagnetic energy that causes said amplifying fluorescent polymer to generate the output signal; and
a MEMS detector positioned to receive the output signal generated by the amplifying fluorescent polymer, said MEMS detector producing an output electrical signal responsive to an interaction between the compound of interest and said amplifying fluorescent polymer.

10. The sensing arrangement of claim 9, wherein the output electrical signal is responsive to a quenching of the output signal of said amplifying fluorescent polymer.

11. The sensing arrangement of claim 9, wherein there is further provided a pattern database for storing pattern data corresponding to characteristics of compounds of interest.

12. A system for detecting explosives of interest from a standoff distance in response to chemical vapors associated with the explosives of interest, The explosives of interest being of the type that absorb infrared energy at predetermined wavelength notches in the 2-20 micron band, the system comprising:
a chamber for receiving the chemical vapors desired to be detected;
a heat source for emitting infrared radiation into said chamber, the infrared radiation having energy in the spectral region of the 2-20 micron band, and
a spectrally tuned infrared detector for detecting a change in the infrared energy in the predetermined wavelength notches in the 2-20 micron band.

13. The system of claim 12, wherein the chemical vapors associated with the explosives of interest are selected from the group consisting of TNT, RDX, HMX, PETN, Tetryl, NG, NC, Taggants (DMNB and EGDN), C-4, SEMTEX, ANFO; plastic bonded explosives (PE and LTPA); and non-nitro explosives (TATP and HMTD).

14. The system of claim 12, wherein the spectrally tuned infrared detector comprises an infrared camera having spectrally selective diffractive optics.

15. The system of claim 14, wherein the selection of the spectral sensitivity of the diffractive optics is determined by linear discriminant methods.

16. The system of claim 14, wherein the spectral sensitivity of the diffractive optics is determined by mechanical articulation of the diffractive optics.

17. The system of claim 12, wherein the spectrally tuned infrared detector comprises a thermally cooled infrared camera.
